(19) United States
(12) Patent Application Publication
(10) Pub. No.: US 2023/0134470 A1
(43) Pub. Date: May 4, 2023

(54) Shotgun Hydroblasting System

(71) Applicant: Thompson Industrial Services, LLC, Sumter, SC (US)

(72) Inventor: Curtis Edward Hodge, Sumter, SC (US)

(21) Appl. No.: 17/513,244

(22) Filed: Oct. 28, 2021

(51) Int. Cl. B08B 9/093; F41B 9/00; B08B 9/032

(52) U.S. Cl. CPC B08B 9/0936; F41B 9/0078; F41B 9/0087; B08B 9/0325; B08B 2209/08; B08B 2209/032

(57) ABSTRACT

A shotgun hydroblasting system includes a chassis. A motor is operable to drive movement of the chassis. A support arm assembly is mounted to the chassis. A shotgun nozzle mounted to the support arm assembly such that the shotgun nozzle is movable relative to the chassis on the support arm assembly. The shotgun nozzle includes a barrel defining a primary outlet for pressurized fluid and a suppressor defining a secondary outlet for the pressurized fluid. The barrel and the suppressor are positioned and oriented such that a force of the pressurized fluid exiting the secondary outlet opposes a force of the pressurized fluid exiting the primary outlet.

### FIELD OF THE INVENTION

The present subject matter relates generally to shotgun hydroblasting systems.

### BACKGROUND OF THE INVENTION

Shotgun hydroblasters are utilized in industrial settings to clean machinery, such as boilers, heat exchangers, tanks, pipes, etc. Shotgun hydroblasters utilize high pressure fluids to remove bio-fouling, waste material, and debris. For example, shotgun hydroblasters can remove scale from pipes using pressurized chemical fluids. Known shotgun hydroblasters have drawbacks, such as user fatigue resulting from manually holding and aiming the shotgun hydroblasters.

### BRIEF DESCRIPTION OF THE INVENTION

Aspects and advantages of the invention will be set forth in part in the following description, or may be apparent from the description, or may be learned through practice of the invention.

In an example embodiment, a shotgun hydroblasting system includes a chassis. A motor is operable to drive movement of the chassis. A support arm assembly is mounted to the chassis. A shotgun nozzle mounted to the support arm assembly such that the shotgun nozzle is movable relative to the chassis on the support arm assembly. The shotgun nozzle includes a barrel defining a primary outlet for pressurized fluid and a suppressor defining a secondary outlet for the pressurized fluid. The barrel and the suppressor are positioned and oriented such that a force of the pressurized fluid exiting the secondary outlet opposes a force of the pressurized fluid exiting the primary outlet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a shotgun hydroblasting system according to an example embodiment of the present subject matter.

FIG. 2 is another perspective view of the example shotgun hydroblasting system of FIG. 1.

FIGS. 3 through 6 are perspective views of the example shotgun hydroblasting system of FIG. 1 with a shotgun nozzle shown in various positions.

FIGS. 7 through 9 are partial, perspective views of the shotgun nozzle of the example shotgun hydroblasting system of FIG. 1.

FIG. 10 is a section view of the shotgun nozzle of the example shotgun hydroblasting system of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

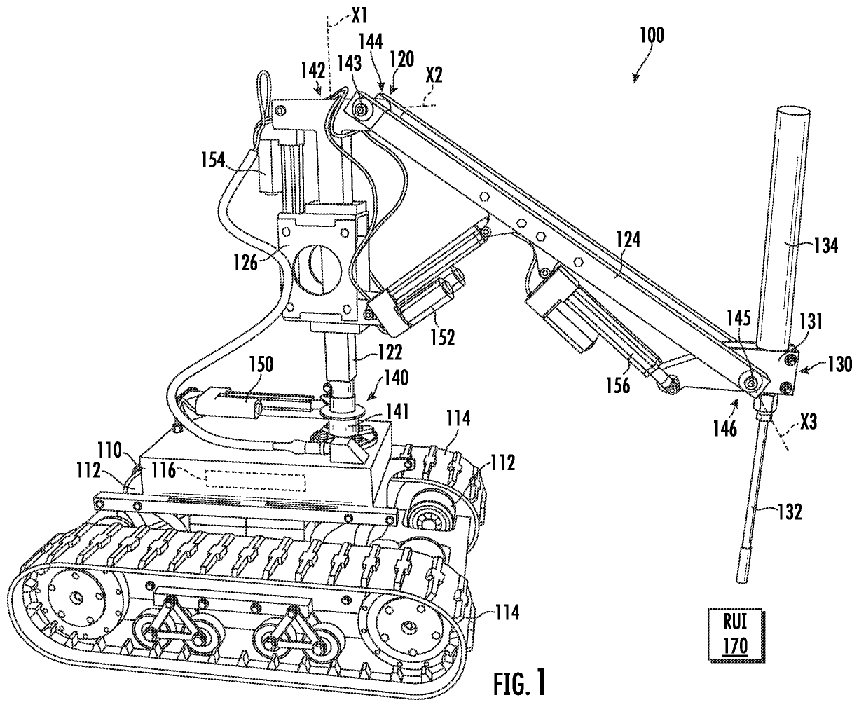

FIGS. 1 through 6 are various views of a shotgun hydroblasting system 100 according to an example embodiment of the present subject matter. Shotgun hydroblasting system 100 may be used to assist with cleaning various industrial equipment. For example, shotgun hydroblasting system 100 may be used to clean boilers, heat exchangers, tanks, pipes, etc. During operation, highly pressurized fluid is delivered to the industrial equipment to remove bio-fouling, waste material, and debris. The pressure of fluid exiting shotgun hydroblasting system 100 can range from ten-thousand pounds per square inch to forty-thousand pounds per square inch (10,000 psi to 40,000 psi).

Shotgun hydroblasting system 100 includes a chassis 110. Chassis 110 may support various operating components of shotgun hydroblasting system 100. Moreover, chassis 110 may be drivable to various locations. Thus, e.g., a user may drive chassis 110 to operating sites. One or more motor(s) 112 may be operable to drive movement of chassis 110. For example, chassis 110 may include a pair of tracks 114. Motor(s) 112 may be coupled to one or both of tracks 114, and motor(s) 112 may be operable to drive one or both of tracks 114 in order to drive movement of chassis 110. It will be understood that in alternative example embodiments, chassis 110 may include wheels or any other suitable mechanism for providing mobility for chassis 110. Motor(s) 112 may be electrically connected to a battery 116 in certain example embodiments, and battery 116 may provide power for operating motor(s) 112. Thus, motor(s) 112 may be an electrical motor. Motor(s) 112 and battery 116 may be disposed within chassis 110, e.g., in order to protect motor(s) 112 and battery 116 from debris and fluid contact. In alterative example embodiments, motor(s) 112 may be an internal combustion engine, a hydraulic motor, a pneumatic motor, etc. for powering movement of chassis 110.

A support arm assembly 120 and a shotgun nozzle 130 are mounted to chassis 110. Thus, when a user operates motor(s) 112 to move chassis 110, support arm assembly 120 and shotgun nozzle 130 also move with chassis 110. Accordingly, chassis 110 may function as a vehicle for transporting support arm assembly 120 and shotgun nozzle 130 around a worksite for shotgun hydroblasting system 100.

Shotgun nozzle 130 is mounted to support arm assembly 120, e.g., such that shotgun nozzle 130 is movable relative to chassis 110 on support arm assembly 120. Moreover, support arm assembly 120 may provide several degrees of freedom for moving shotgun nozzle 130 relative to chassis 110. For example, in some embodiments, support arm assembly 120 may provide two, three, four, or more degrees of freedom for moving shotgun nozzle 130 relative to chassis 110. Utilizing support arm assembly 120, a user of shotgun hydroblasting system 100 may aim a stream of pressurized fluid exiting shotgun nozzle 130 towards a target.

Support arm assembly 120 may include a first support arm 122 and a second support arm 124. First support arm 122 may be mounted to chassis 110, and second support arm 124 may be mounted to first support arm 122. First support arm 122 may be rotatably mounted to chassis 110. Moreover, first support arm 122 may be rotatable about a first axis X1 relative to chassis 110. The first axis X1 may be about vertical in certain example embodiments, such as when chassis 110 is resting on level ground. Second support arm 124 may be rotatably mounted to first support arm 122. Moreover, second support arm 124 may be rotatable about a second axis X2 relative to first support arm 122. In certain example embodiments, the first axis X1 may be about perpendicular to the second axis X2. Thus, e.g., the second axis X2 may be about horizontal in certain example embodiments, such as when chassis 110 is resting on level ground. Shotgun nozzle 130 may be mounted to second support arm 124. Shotgun nozzle 130 may also be rotatable relative to second support arm 124. Moreover, shotgun nozzle 130 may be rotatable about a third axis X3 relative to second support arm 124. In certain example embodiments, the third axis X3 may be about perpendicular to the first axis X1 and/or about parallel to the second axis X2. Thus, e.g., the third axis X3 may be about horizontal in certain example embodiments, such as when chassis 110 is resting on level ground.

First support arm 122 may be elongated. Thus, e.g., first support arm 122 may extend between a first or proximal end portion 140 and a second or distal end portion 142. Proximal end portion 140 of first support arm 122 may be positioned at chassis 110. Moreover, first support arm 122 may be rotatably mounted to chassis 110 at proximal end portion 140 of first support arm 122, e.g., with a bearing 141, within which proximal end portion 140 of first support arm 122 is received. Distal end portion 142 of first support arm 122 may be, e.g., vertically, spaced apart from proximal end portion 140 of first support arm 122. Thus, e.g., distal end portion 142 of first support arm 122 may be positioned above chassis 110. In certain example embodiments, first support arm 122 may be about vertically oriented, such as when chassis 110 is resting on level ground, with distal end portion 142 of first support arm 122 positioned directly above proximal end portion 140 of first support arm 122.

Second support arm 124 may also be elongated. Thus, e.g., second support arm 124 may extend between a first or proximal end portion 144 and a second or distal end portion 146. Proximal end portion 144 of second support arm 124 may be mounted to first support arm 122, e.g., at distal end portion 142 of first support arm 122. Moreover, second support arm 124 may be rotatably mounted to first support arm 122 at proximal end portion 144 of second support arm 124, e.g., by a pin 143 that extends through first and second support arms 122, 124 at distal end portion 142 of first support arm 122 and proximal end portion 144 of second support arm 124. Distal end portion 146 of second support arm 124 may be, e.g., laterally, spaced apart from proximal end portion 144 of second support arm 124. Thus, e.g., distal end portion 146 of second support arm 124 may be cantilevered from first support arm 122.

Shotgun nozzle 130 may be mounted to second support arm 124 at distal end portion 146 of second support arm 124. Thus, shotgun nozzle 130 may also be cantilevered on second support arm 124 from first support arm 122. Moreover, shotgun nozzle 130 may be rotatably mounted to second support arm 124 at distal end portion 146 of second support arm 124, e.g., by a pin 145 that extends through second support arm 124 and shotgun nozzle 130 at distal end portion 146 of second support arm 124.

Shotgun hydroblasting system 100 may include a plurality of actuators for rotating the components of support arm assembly 120 and/or shotgun nozzle 130. The actuators may include electrical motors, hydraulic motors, pneumatic motors, electrical linear actuators, hydraulic linear actuators, pneumatic linear actuators, etc. configured for rotating the components of support arm assembly 120 and/or shotgun nozzle 130. As an example, the plurality of actuators may include a first linear actuator 150, a second linear actuator 152, a third linear actuator 154, and/or a fourth linear actuator 156.

First linear actuator 150 may be coupled to first support arm 122 and chassis 110. For instance, one end of first linear actuator 150 may be rotatably positioned at and connected to first support arm 122, and a second, opposite end of first linear actuator 150 may be positioned at and connected to chassis 110. In certain example embodiments, first linear actuator 150 may be coupled to first support arm 122 at proximal end portion 140 of first support arm 122. First linear actuator 150 may be operable to rotate first support arm 122 relative to chassis 110. For example, by selectively retracting and extending a length of first linear actuator 150, a user may drive rotation of first support arm 122 about the first axis X1 relative to chassis 110.

Second linear actuator 152 may be coupled to first and second support arms 122, 124. For instance, one end of second linear actuator 152 may be rotatably positioned at and connected to first support arm 122 (e.g., between proximal and distal end portions 140, 142 of first support arm 122), and a second, opposite end of second linear actuator 152 may be positioned at and connected to second support arm 124 (e.g., between proximal and distal end portions 144, 146 of second support arm 124). Second linear actuator 152 may be operable to rotate second support arm 124 relative to first support arm 122. For example, by selectively retracting and extending a length of second linear actuator 152, a user may drive rotation of second support arm 124 about the second axis X2 relative to first support arm 122.

In certain example embodiments, support arm assembly 120 may also include a bracket 126. Bracket 126 may be slidably mounted to first support arm 122, e.g., between proximal and distal end portions 140, 142 of first support arm 122. Thus, e.g., a position or height of bracket 126 may be adjusted by sliding bracket 126 on first support arm 122. Third linear actuator 154 may be coupled to first support arm 122 and bracket 126, and third linear actuator 154 may be operable to slide bracket 126 on first support arm 122. By moving bracket 126 on first support arm 122, a range of motion for second support arm 124 about the second axis X2 relative to first support arm 122 may be increased. For instance, one end of second linear actuator 152 may be coupled to bracket 126. Moreover, the one end of second linear actuator 152 rotatably positioned at and connected to first support arm 122 may be mounted to bracket 126. When third linear actuator 154 moves bracket 126, a pivot point for second linear actuator 152 may also move. Thus, relative to a fixed pivot point for second linear actuator 152 on first support arm 122, the range of motion for second support arm 124 about the second axis X2 relative to first support arm 122 may be increased by moving bracket 126 on first support arm 122.

Fourth linear actuator 156 may be coupled to second support arm 124 and shotgun nozzle 130. For instance, one end of fourth linear actuator 156 may be rotatably positioned at and connected to second support arm 124 (e.g., between proximal and distal end portions 144, 146 of second support arm 124), and a second, opposite end of fourth linear actuator 156 may be positioned at and connected to shotgun nozzle 130. Fourth linear actuator 156 may be operable to rotate shotgun nozzle 130 relative to second support arm 124. For example, by selectively retracting and extending a length of fourth linear actuator 156, a user may drive rotation of shotgun nozzle 130 about the third axis X3 relative to second support arm 124.

Shotgun nozzle 130 is configured directed a stream of pressurized fluid towards a target. Shotgun nozzle 130 may include a barrel 132 and a suppressor 134. Barrel 132 may define a primary outlet 136 for pressurized fluid, and suppressor 134 may define a secondary outlet 138 for the pressurized fluid. Primary outlet 136 may be positioned and oriented for directing the pressurized fluid towards the target. Thus, the pressurized fluid exiting shotgun nozzle 130 at primary outlet 136 may flow towards the target, e.g., to assist with cleaning the target.

The pressurized fluid exiting shotgun nozzle 130 at primary outlet 136 may generate a force opposite to the direction of the pressurized fluid exiting shotgun nozzle 130 at primary outlet 136. Suppressor 134 is configured to assist with balancing the force generated by the pressurized fluid exiting shotgun nozzle 130 at primary outlet 136. Thus, barrel 132 and suppressor 134 may be positioned and oriented such that the force of the pressurized fluid exiting secondary outlet 138 opposes the force of the pressurized fluid exiting primary outlet 136. By at least partially balancing the force generated by the pressurized fluid exiting shotgun nozzle 130 at primary outlet 136, suppressor 134 may assist with reducing undesirable movement of shotgun nozzle 130 and/or advantageously increasing a stability of primary outlet 136 during operation of shotgun hydroblasting system 100. Thus, a user of shotgun hydroblasting system 100 may more accurately and precisely aim the pressurized fluid exiting shotgun nozzle 130 at primary outlet 136 towards the target due to suppressor 134. In certain example embodiments, a cross-section area of primary outlet 136 may be about equal to a corresponding cross-section area of secondary outlet 138. Thus, primary outlet 136 and secondary outlet 138 may be, e.g., about, commonly sized. In addition, primary outlet 136 may be aligned coaxially with secondary outlet 138. Such sizing and/or alignment may assist with balancing the force generated by pressurized fluid exiting shotgun nozzle 130 at primary outlet 136 with pressurized fluid exiting shotgun nozzle 130 at secondary outlet 138.

Shotgun nozzle 130 may include a nozzle body 131. Nozzle body 131 may be mounted to second support arm 124 at distal end portion 146 of second support arm 124. For example, pin 145 may extend through second support arm 124 and nozzle body 131 at distal end portion 146 of second support arm 124. Barrel 132 and suppressor 134 may be mounted to nozzle body 131 at opposite side of nozzle body 131. Shotgun nozzle 130 may further include a coupling 137 defining an inlet 139 for the pressurized fluid. Coupling 137 may be mounted to nozzle body 131 between barrel 132 and suppressor 134. As an example, a hose or other suitable fluid conduit may be connected to shotgun nozzle 130 at coupling 137. Pressurized fluid may be supplied to shotgun nozzle 130 at inlet 139 of coupling 137 via the hose or other suitable fluid conduit. In certain example embodiments, barrel 132, suppressor 134, and coupling 137 may be threaded to nozzle body 131.

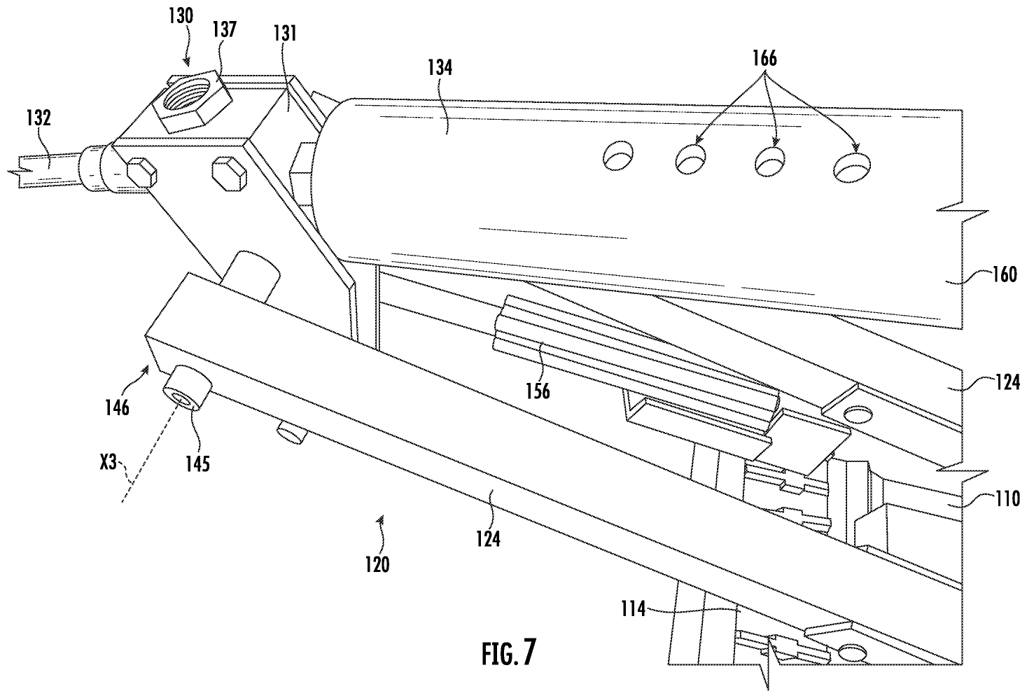

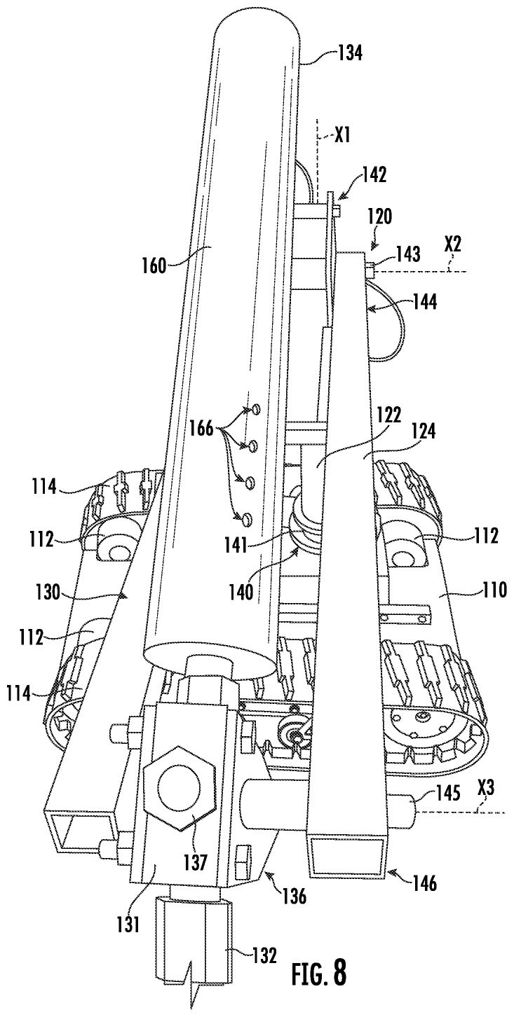

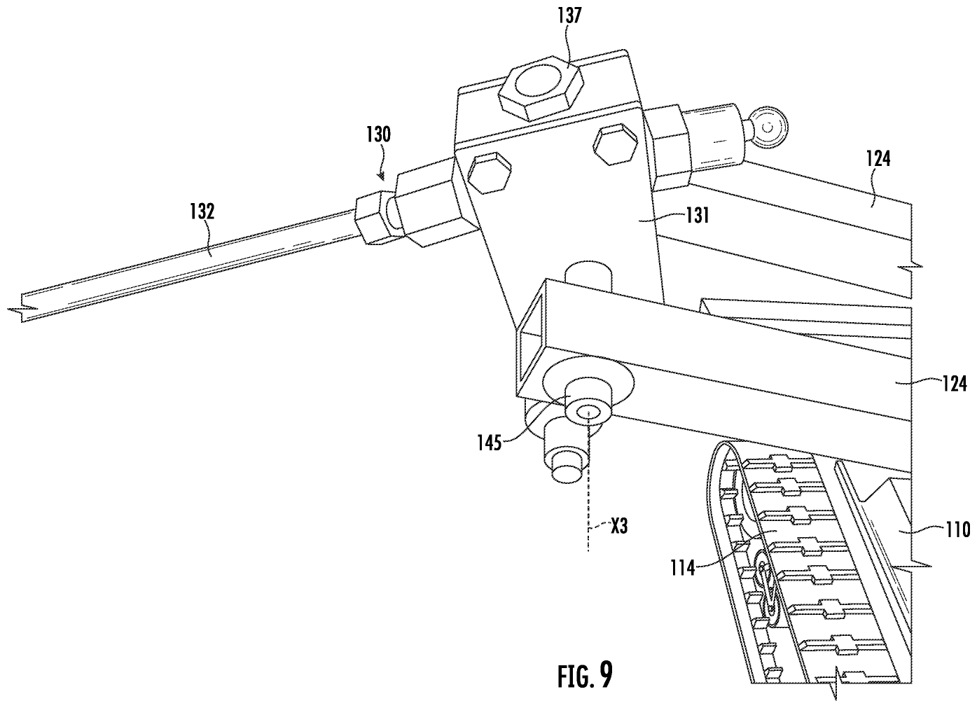

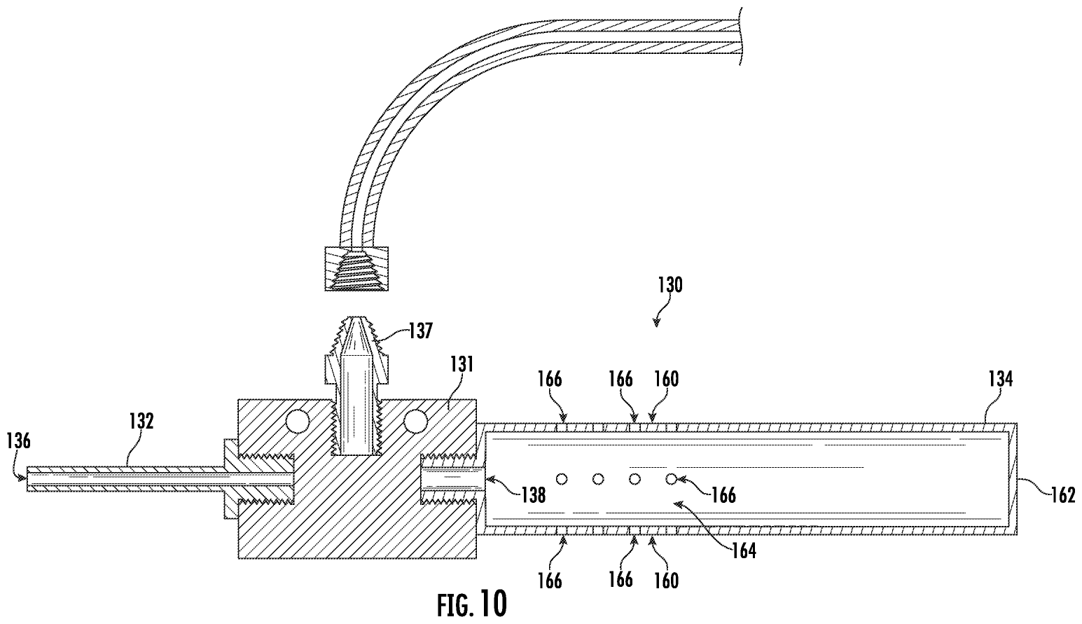

As noted above, suppressor 134 may assist with balancing the force generated by pressurized fluid exiting shotgun nozzle 130 at primary outlet 136. Turning to FIGS. 7 through 10, suppressor 134 may include a shroud 160. In certain example embodiments, shroud 160 may be a tubular casing, such as a cylindrical metal tube. Shroud 160 may have an end wall 162, and shroud 160 may define an interior chamber 164. Interior chamber 164 may extend between secondary outlet 138 and end wall 162 within shroud 160. Shroud 160 may also define a plurality of vents 166 for interior chamber 164 between secondary outlet 138 and end wall 162. Vents 166 may be positioned proximate secondary outlet 138 on shroud 160. Vents 166 may be distributed axially and/or circumferentially on shroud 160. In certain example embodiments, embodiments, a length of shroud 160, e.g., between secondary outlet 138 and end wall 162, may be about no less than twelve inches (12″) and no greater than thirty-six inches (36″). For instance, the length of shroud 160 may be about twenty-six inches (26″). In certain example embodiments, embodiments, a diameter of shroud 160 may be no less than one and a half inches (1.5″) and no greater than four and a half inches (4.5″). For instance, the diameter of shroud 160 may be about two and half inches (2.5″).

Shroud 160 may assist with redirecting the pressurized fluid exiting secondary outlet 138. For instance, pressurized fluid exiting secondary outlet 138 may enter into interior chamber 164. At the end of interior chamber 164, the pressurized fluid may impact against end wall 162. The fluid may then exit interior chamber 164 via vents 166. Accordingly, shroud 160 (e.g., end wall 162) may block the pressurized fluid exiting secondary outlet 138 from flowing directly away from the target for primary outlet 136, while also allowing suppressor 134 to assist with balancing the force generated by pressurized fluid exiting shotgun nozzle 130 at primary outlet 136 with the force generated by pressurized fluid exiting shotgun nozzle 130 at secondary outlet 138. For example, a user of shotgun hydroblasting system 100 may stand behind barrel 132 to observe a target for pressurized fluid exiting shotgun nozzle 130 at primary outlet 136, and shroud 160 may redirect pressurized fluid exiting secondary outlet 138 away from the user and other items located behind barrel 132.

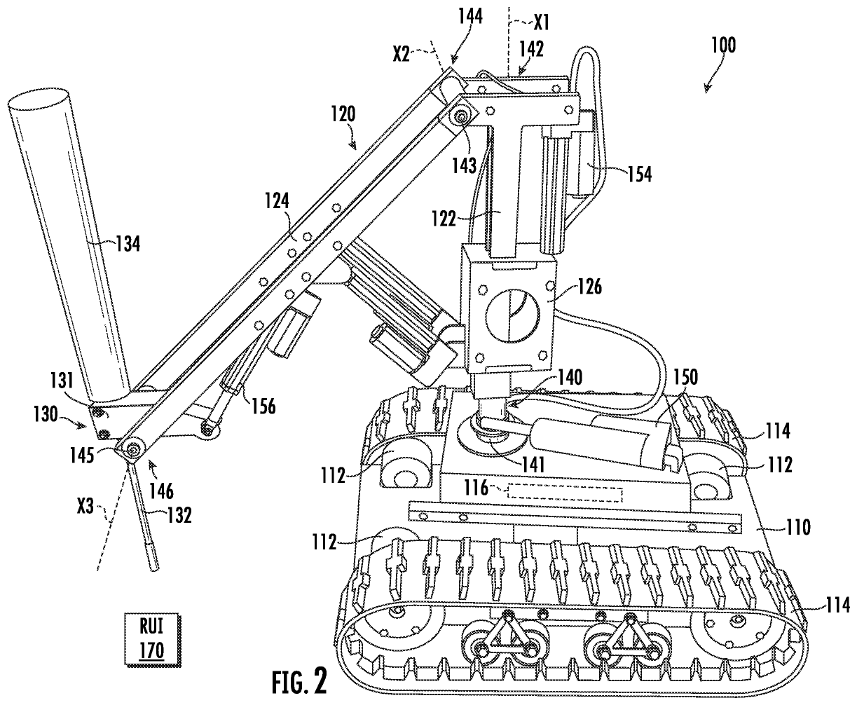

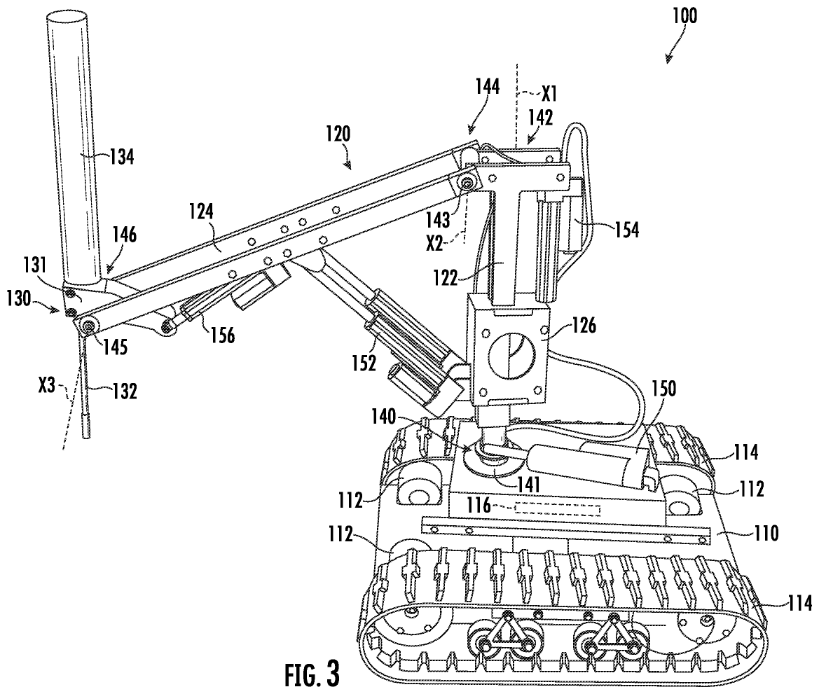

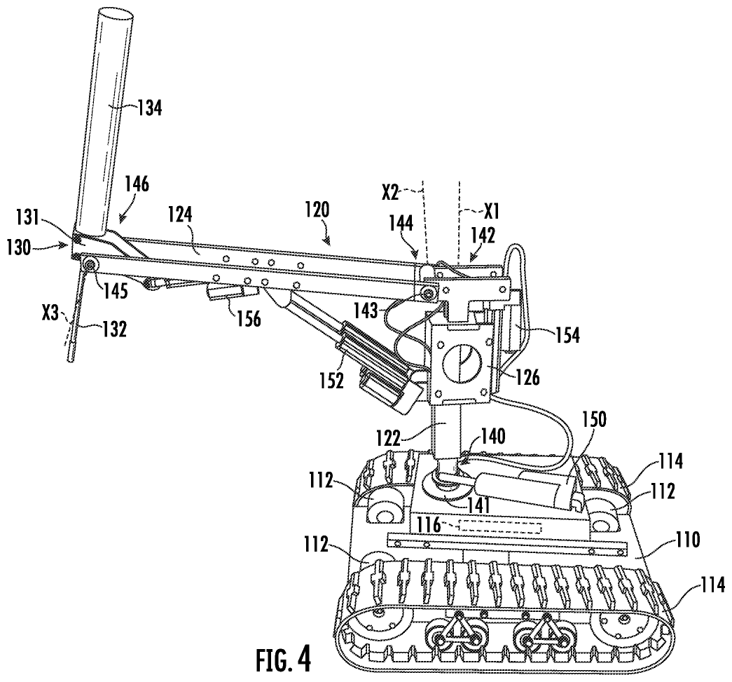

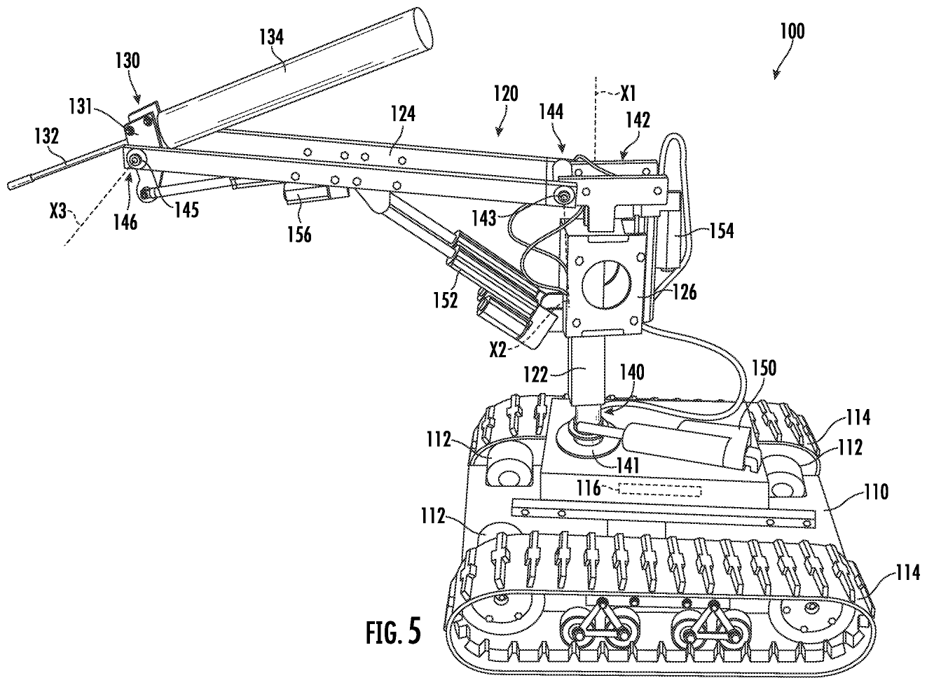

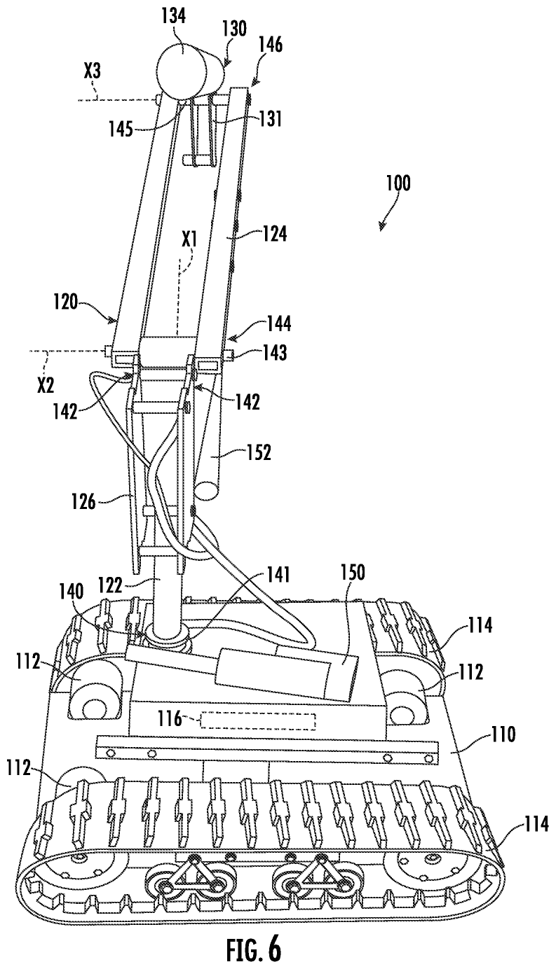

Operation of shotgun hydroblasting system 100 will now be described in greater detail below. A user of shotgun hydroblasting system 100 may first position shotgun hydroblasting system 100 in a general vicinity of a target. Thus, the user may activate motor(s) 112 to drive chassis 110 towards the target. In certain example embodiments, tracks 114 may allow chassis 110 to traverse rough terrain and/or stairs to approach target. With shotgun hydroblasting system 100 positioned near the target by driving chassis, the user may then utilize support arm assembly 120 to aim shotgun nozzle 130 by adjusting the position and/or orientation of shotgun nozzle 130 with support arm assembly 120. For example, the user may activate one or more of: first linear actuator 150 to drive rotation of first support arm 122 relative to chassis 110; second linear actuator 152 to drive rotation of second support arm 124 relative to first support arm 122; third linear actuator 154 to slide bracket 126 on first support arm 122; and fourth linear actuator 156 to drive rotation of shotgun nozzle 130 relative to second support arm 124. Thus, as shown in FIGS. 2 and 3, the user may activate second linear actuator 152 to drive rotation of second support arm 124 about the second axis X2 relative to first support arm 122 between the two configurations shown in FIGS. 2 and 3 as well as other rotational positions. Turning to FIGS. 3 and 4, the user may activate third linear actuator 154 to slide bracket 126 on first support arm 122 between the two configurations shown in FIGS. 3 and 4 as well as other positions. By moving bracket 126, the user may also drive rotation of second support arm 124 about the second axis X2 relative to first support arm 122 between the two configurations shown in FIGS. 3 and 4 as well as other rotational positions. Turning to FIGS. 4 and 5, the user may activate fourth linear actuator 156 to drive rotation of shotgun nozzle 130 about the third axis X3 relative to second support arm 124 between the two configurations shown in FIGS. 4 and 5 as well as other rotational positions. Turning to FIGS. 5 and 6, the user may active first linear actuator 150 to drive rotation of first support arm 122 about the first axis X1 relative to chassis 110 between the two configurations shown in FIGS. 5 and 6 as well as other rotational positions. As may be seen from the above, by selectively operating the various actuators of shotgun hydroblasting system 100, the user may control the position and/or orientation of shotgun nozzle 130 during operation of shotgun hydroblasting system 100. It will be understood that the various actuators of shotgun hydroblasting system 100 may be operating singly or in combination to aim shotgun nozzle 130 during operation of shotgun hydroblasting system 100

The various actuators of shotgun hydroblasting system 100 may allow the user to control the direction of pressurized fluid exiting shotgun nozzle 130 at primary outlet 136 towards the target. The user may utilize a remote user interface 170, such as a wired or wireless remote control, configured for controlling operation of shotgun hydroblasting system 100. The remote user interface 170 may allow the user to selectively activate motor(s) 112, first linear actuator 150, second linear actuator 152, third linear actuator 154, and/or fourth linear actuator 156 in the manner described above. Thus, remote user interface 170 may include button(s), joystick(s), trigger(s), and other user inputs for controlling operation of shotgun hydroblasting system 100 in response to user inputs at remote user interface 170.

Utilizing shotgun hydroblasting system 100, the user may advantageously avoid the fatigue associate with manually cleaning surfaces via shotgun hydroblasting. Moreover, the mobility of the shotgun nozzle 130 provided by shotgun hydroblasting system 100 is significantly better than known automated hydroblasting systems that offer limited degrees of freedom. Suppressor 134 may assist with allowing such increased mobility by at least partially balancing the force generated by pressurized fluid exiting shotgun nozzle 130 at primary outlet 136 and thereby allowing precise control of the position and orientation of shotgun nozzle 130, e.g., despite shotgun nozzle 130 being cantilevered on support arm assembly 120.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A shotgun hydroblasting system, comprising:
a chassis;
a motor operable to drive movement of the chassis;
a support arm assembly mounted to the chassis; and
a shotgun nozzle mounted to the support arm assembly such that the shotgun nozzle is movable relative to the chassis on the support arm assembly, the shotgun nozzle comprising
a barrel defining a primary outlet for pressurized fluid, and
a suppressor defining a secondary outlet for the pressurized fluid,
wherein the barrel and the suppressor are positioned and oriented such that a force of the pressurized fluid exiting the secondary outlet opposes a force of the pressurized fluid exiting the primary outlet.

2. The shotgun hydroblasting system of claim 1, wherein the support arm assembly comprises:
a first support arm mounted to the chassis; and
a second support arm mounted to the first support arm, the second support arm rotatable relative to the first support arm,
wherein the shotgun nozzle is mounted to the second support arm such that the shotgun nozzle is rotatable relative to the second support arm.

3. The shotgun hydroblasting system of claim 2, wherein:
a proximal end portion of the first support arm is positioned at the chassis;
a distal end portion of the first support arm is positioned above the chassis;
a proximal end portion of the second support arm is rotatably mounted to the first support arm at the distal end portion of the first support arm; and
the shotgun nozzle is mounted to the second support arm at a distal end portion of the second support arm.

4. The shotgun hydroblasting system of claim 2, wherein the first support arm is mounted to the chassis such that the first support arm is rotatable relative to the chassis.

5. The shotgun hydroblasting system of claim 4, further comprising a linear actuator coupled to the first support arm and the chassis, the linear actuator operable to rotate the first support arm relative to the chassis.

6. The shotgun hydroblasting system of claim 2, further comprising a first linear actuator coupled to the first and second support arms, the first linear actuator operable to rotate the second support arm relative to the first support arm.

7. The shotgun hydroblasting system of claim 6, further comprising a bracket slidably mounted to the first support arm, wherein an end of the first linear actuator is coupled to the bracket.

8. The shotgun hydroblasting system of claim 7, further comprising a second linear actuator coupled to the first support arm and the bracket, the second linear actuator operable to slide the bracket on the first support arm.

9. The shotgun hydroblasting system of claim 2, further comprising a linear actuator coupled to the second support arm and the shotgun nozzle, the linear actuator operable to rotate the shotgun nozzle relative to the second support arm.

10. The shotgun hydroblasting system of claim 1, further comprising a plurality of linear actuators, wherein:
the support arm assembly comprises a first support arm mounted to the chassis and a second support arm mounted to the first support arm, the second support arm rotatable relative to the first support arm, the shotgun nozzle mounted to the second support arm such that the shotgun nozzle is rotatable relative to the second support arm;
the first support arm is mounted to the chassis such that the first support arm is rotatable relative to the chassis, a first one of the plurality of linear actuators coupled to the first support arm and the chassis, the first one of the plurality of linear actuators operable to rotate the first support arm relative to the chassis;
a second one of the plurality of linear actuators coupled to the first and second support arms, the second one of the plurality of linear actuators operable to rotate the second support arm relative to the first support arm;
a bracket slidably is mounted to the first support arm, an end of the second one of the plurality of linear actuators coupled to the bracket, a third one of the plurality of linear actuators coupled to the first support arm and the bracket, the third one of the plurality of linear actuators operable to slide the bracket on the first support arm; and
a fourth one of the plurality of linear actuators is coupled to the second support arm and the shotgun nozzle, the fourth one of the plurality of linear actuators operable to rotate the shotgun nozzle relative to the second support arm.

11. The shotgun hydroblasting system of claim 10, wherein:
a proximal end portion of the first support arm is positioned at the chassis;
a distal end portion of the first support arm is positioned above the chassis;
a proximal end portion of the second support arm is rotatably mounted to the first support arm at the distal end portion of the first support arm; and
the shotgun nozzle is mounted to the second support arm at a distal end portion of the second support arm.

12. The shotgun hydroblasting system of claim 1, further comprising a battery, the motor electrically connected to the battery, the motor and the battery disposed within the chassis.

13. The shotgun hydroblasting system of claim 1, further comprising a pair of tracks, the motor coupled to one or both of the pair of tracks, the motor operable to drive the one or both of the pair of tracks in order to drive movement of the chassis.

14. The shotgun hydroblasting system of claim 1, wherein:
the shotgun nozzle further comprises a nozzle body mounted to the support arm assembly such that the nozzle body is rotatable relative to the support arm assembly; and
the barrel and the suppressor are mounted to the nozzle body at opposite side of the nozzle body.

15. The shotgun hydroblasting system of claim 14, wherein the shotgun nozzle further comprises a coupling defining an inlet for the pressurized fluid, the coupling mounted to the nozzle body between the barrel and the suppressor.

16. The shotgun hydroblasting system of claim 15, wherein the barrel, the suppressor, and the coupling are threaded to the nozzle body.

17. The shotgun hydroblasting system of claim 14, wherein the suppressor comprises a shroud having an end wall and defining an interior chamber between the secondary outlet and the end wall, the shroud defining a plurality of vents for the interior chamber between the secondary outlet and the end wall.

18. The shotgun hydroblasting system of claim 17, wherein a plurality of vents are positioned proximate the secondary outlet on the shroud.

19. The shotgun hydroblasting system of claim 1, further comprising a remote user interface configured for controlling operation of the shotgun hydroblasting system.
